(19) United States
(12) Patent Application Publication
(10) Pub. No.: US 2013/0311861 A1
(43) Pub. Date: Nov. 21, 2013

(54) Effect Editing Methods, Systems, Application Products and Electronic Devices for Electronic Books

(71) Applicants: Shih Scott, New Taipei City (TW); Daniel Hsu, Hsinchu County (TW)

(72) Inventors: Shih Scott, New Taipei City (TW); Daniel Hsu, Hsinchu County (TW)

(73) Assignee: CHIDOPI CO., LTD., Taipei City (TW)

(21) Appl. No.: 13/474,712

(22) Filed: May 18, 2012

(51) Int. Cl. G06F 17/24

(52) U.S. Cl. 715/205

(57) ABSTRACT

An effect editing method for electronic books (e-books) is provided to edit an e-book page displayed on a touch-sensitive screen of an electronic device. The method includes following steps: (a) separating the e-book page into a plurality of sub-regions, each having a position parameter; (b) recording a first position parameter corresponding to a first sub-region, which is selected at beginning, and a second position parameter corresponding to a second sub-region, which is selected at ending; and (c) linking the first position parameter, the second position parameter, and position parameters between the first position parameter and the second position parameter to an effect, thus making the touch-sensitive screen of the electronic device to display the e-book page, and performing the effect when the selected sub-region is triggered. The efficacy of the present invention can automatically select several sub-regions, thereby reducing operational time, and improving the manufacturing efficiency of e-books.

### BACKGROUND OF THE INVENTION

1. Field of the Invention

The disclosure relates generally to editing methods, systems, application products and electronic devices for electronic books (e-books), and more particularly, to effect editing methods, systems, application products and electronic devices for electronic books that reduce manufacturing time and costs.

2. Description of the Related Art

Referring to FIG. 1, an e-book reading device 9, such as iPad can download applications corresponding to several e-books from on-line stores. The e-book reading device 9 has a touch-sensitive screen 91 of the e-book reading device. The touch-sensitive screen 91 displays icons 911 representing various e-book files. Users can touch/select any icon 911 using a finger 92, thus to launch the corresponding e-book application.

Referring to FIG. 2, an e-book browser 8 can be generated after the e-book application of the e-book reading device 9 is launched. The e-book browser 8 has a skin area 81 and a content area 82. The skin area 81 is always located at the top of the e-book browser 8, and displayed as a banner, in which the skin area 81 can mainly set for function buttons 811. The content area 82 can automatically determine the display size of a page 821 according to the size specification of the touch-sensitive screen 91, and users can perform magnification or minification operations to the content of the page 821.

Further, the content of the page 821 can embed with multimedia objects, such as sounds or videos. The page 821 had arranged how to trigger the multimedia object (ex., touch control), and what corresponding effect to show (ex., playing sound or video) in advance, and the page 821 will display a custom playback icon 822 to represent the corresponding object. When users press the playback icon 822, the multimedia content will be played back.

However, in the arrangement manner of inserting above multimedia effect to the page 821 of the e-book, a publisher or an author must prepare content data of texts and figures, and deliver the content data to an information company for typesetting and manufacturing the content data as an e-book application. Then, the on-line store can provide users to download the e-book application into their e-book reading device 9 for browsing. It is time-consuming and costly for the communication process of how to typeset the multimedia effect between the publisher or author and the information company.

Additionally, a html page embedded with a flash animation, for example, although FLASH rendering software can be used to circle a specific region (ex., the outline of a spaceman) in the page to be the region, in which the effect is played back when the region is touched, general users who never learn similar software will not know how to operate. Related operations are also needed to be processed by the specialized information company, it is inconvenient.

### BRIEF SUMMARY OF THE INVENTION

The objectives of the present invention is to provide effect editing methods, systems, application products and electronic devices for electronic books, in which what you see is what you get, that is easily operated, thus to reduce manufacturing time and costs.

An effect editing method for electronic books of the present invention is used to edit an e-book page displayed on a touch-sensitive screen of an electronic device. The method includes following steps: (a) separating the e-book page into a plurality of sub-regions, each having a position parameter; (b) recording a first position parameter corresponding to a first sub-region, which is selected at beginning, and a second position parameter corresponding to a second sub-region, which is selected at ending; and (c) linking the first position parameter, the second position parameter, and position parameters between the first position parameter and the second position parameter to an effect, thus making the touch-sensitive screen of the electronic device to display the e-book page, and performing the effect when the selected sub-region is triggered.

An effect editing system for electronic books of the present invention comprises a controller used for coordinating and controlling operations of respective components, a display unit, controlled by the controller, for displaying an e-book page to be displayed in a touch-sensitive screen of an electronic device, and a memory provided to the controller for accessing data.

The memory, provided to the controller for accessing data, stores an application product. The application product comprises region allocation data, effect linking data, and a main program. The region allocation data corresponds to the sub-regions divided from the e-book page, and records position parameters corresponding to the respective selected sub-regions. The effect linking data records a first position parameter corresponding to a first sub-region, which is selected at beginning, and a second position parameter corresponding to a second sub-region, which is selected at ending, and the first position parameter and the second position parameter corresponding to the selected sub-regions, and position parameters between the first position parameter and the second position parameter are linked to an effect. The main program provides the controller, when executed, making the touch-sensitive screen to display the e-book page, and performing the effect when the selected sub-region is triggered.

An application product of electronic books of the present invention is executed in an electronic device comprising a touch-sensitive screen for displaying an e-book page, wherein the application product is characterized in the e-book page is divided into a plurality of sub-regions, each having a position parameter; a first position parameter corresponding to a first sub-region, which is selected at beginning, a second position parameter corresponding to a second sub-region, which is selected at ending, and position parameters between the first position parameter and the second position parameter are linked to an effect, the touch-sensitive screen of the electronic device is enabled to display the e-book page, and the effect is performed when the selected sub-region is triggered.

An electronic device of the present invention executes predefined program logic, wherein the predefined program logic links first position parameter corresponding to a first sub-region, which is selected at beginning, a second position parameter corresponding to a second sub-region, which is selected at ending, and position parameters between the first position parameter and the second position parameter to an effect, makes the touch-sensitive screen of the electronic device to display the e-book page, and performs the effect when the selected sub-region is triggered.

The efficacy of the effect editing methods, systems, application products and electronic devices for electronic books of the present invention can automatically select several sub-regions, thereby reducing operational time, and improving the manufacturing efficiency of e-books.

Effect editing methods for electronic books may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an existed e-book reading device;

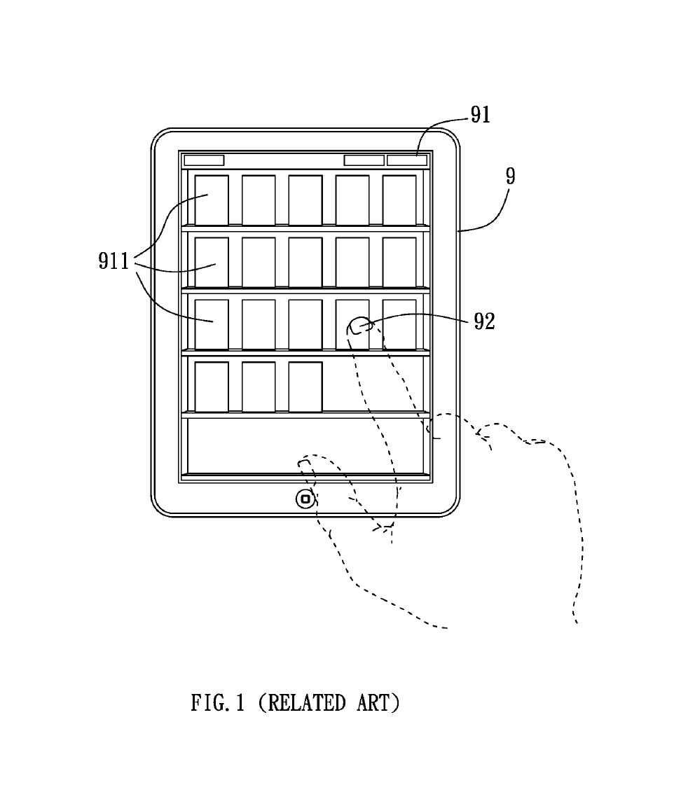

FIG. 2 is a schematic diagram illustrating a picture of an application program of e-books;

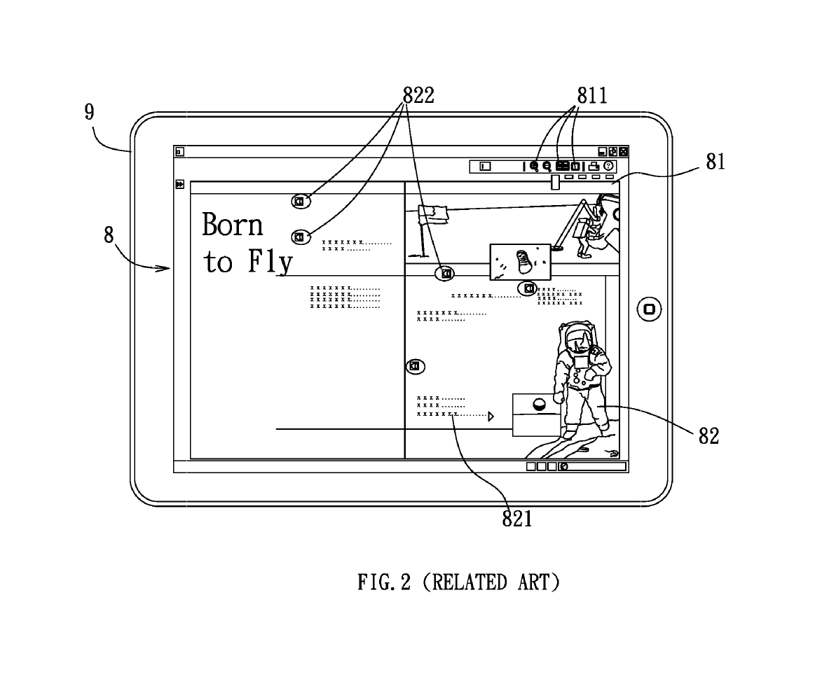

FIG. 3 is a system block diagram illustrating an embodiment of an effect editing system for electronic books of the invention;

FIG. 4 is a flowchart of an embodiment of an effect editing method for electronic books of the invention;

FIG. 5 is a flowchart of a first implementation manner of automatic selection recording of the effect editing method for electronic books of the invention;

FIG. 6 is a flowchart of a second implementation manner of automatic selection recording of the effect editing method for electronic books of the invention;

FIG. 7 is a schematic diagram illustrating an editing picture displayed on the screen of the effect editing system for electronic books of the invention;

FIG. 8 is a schematic diagram illustrating an e-book page displayed in the electronic device of the invention;

FIG. 9 is a schematic diagram illustrating an editing picture displayed on the screen of the effect editing system for electronic books of the invention; and

FIG. 10 is a schematic diagram illustrating an e-book page displayed in the electronic device of the invention.

### DETAILED DESCRIPTION OF THE INVENTION

Effect editing methods, systems, application products and electronic devices for electronic books are provided.

It is specially emphasized that, the electronic device of the present invention may be an iPad, handheld device, or tablet computer. However, it is understood that, related persons skilled in the art of the present invention should know the electronic device is not limited thereto. Any electronic device can display the editing effect of the present application can be also used in the present invention, and are covered within the scope of the present invention. Also, in addition to the application product, no matter what predefined program logic, program language or development kit is used for development, any similar concept applying the operation logic of the method of the present invention will also be belong to the scope of the present invention, and the present invention is not limited thereto.

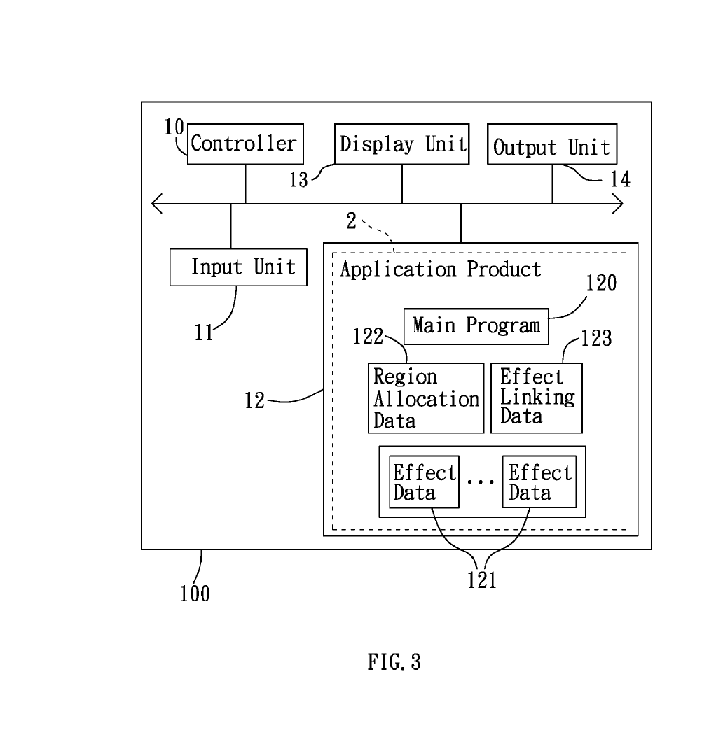

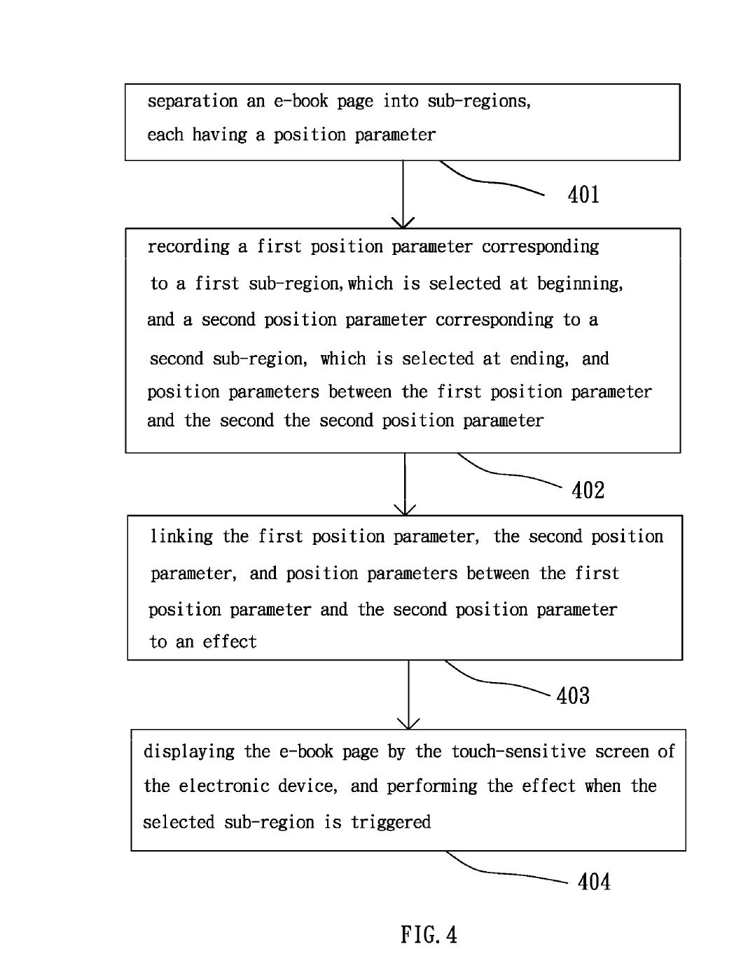

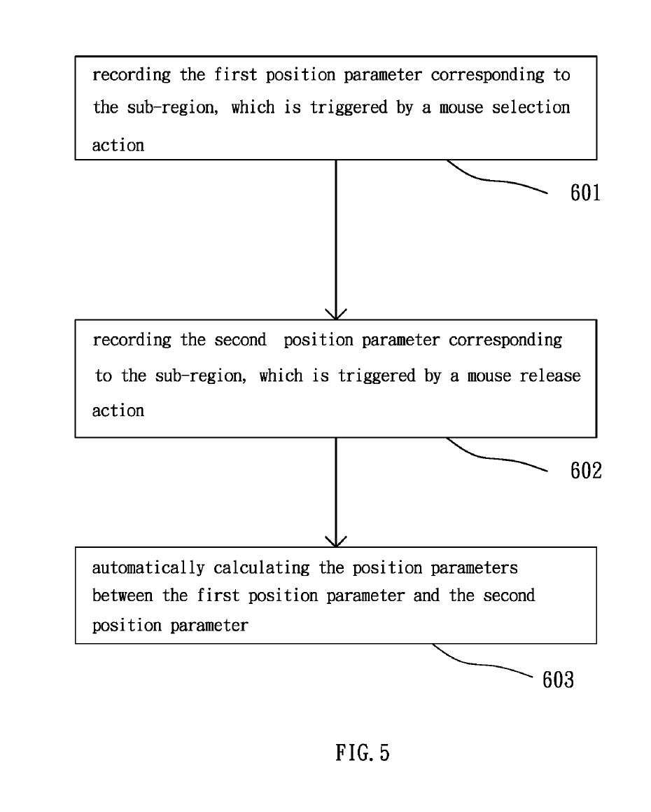

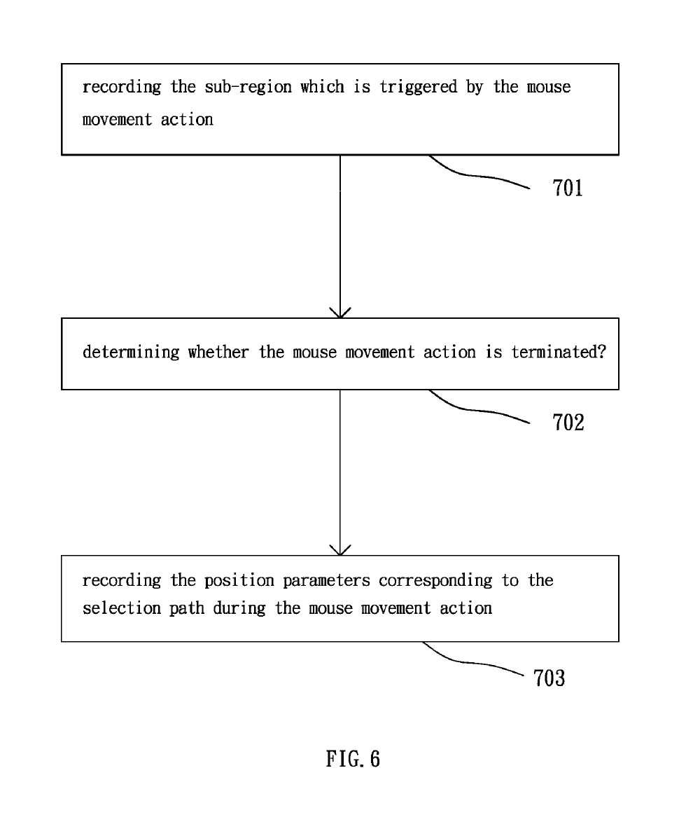

The effect editing system 100 for electronic books of the present invention in FIG. 3 performs steps 401-404 of the effect editing method for electronic books of the present invention in FIG. 4, in which step 402 of FIG. 4 has two implementation manners, as shown in FIG. 5 and FIG. 6, respectively. The principle of the present invention is disclosed as follows.

Referring to FIG. 3, the effect editing system 100 comprises a controller 10, an input unit 11, a memory 12, a display unit 13 and an output unit 14, in which the memory 12 records the described application product 2.

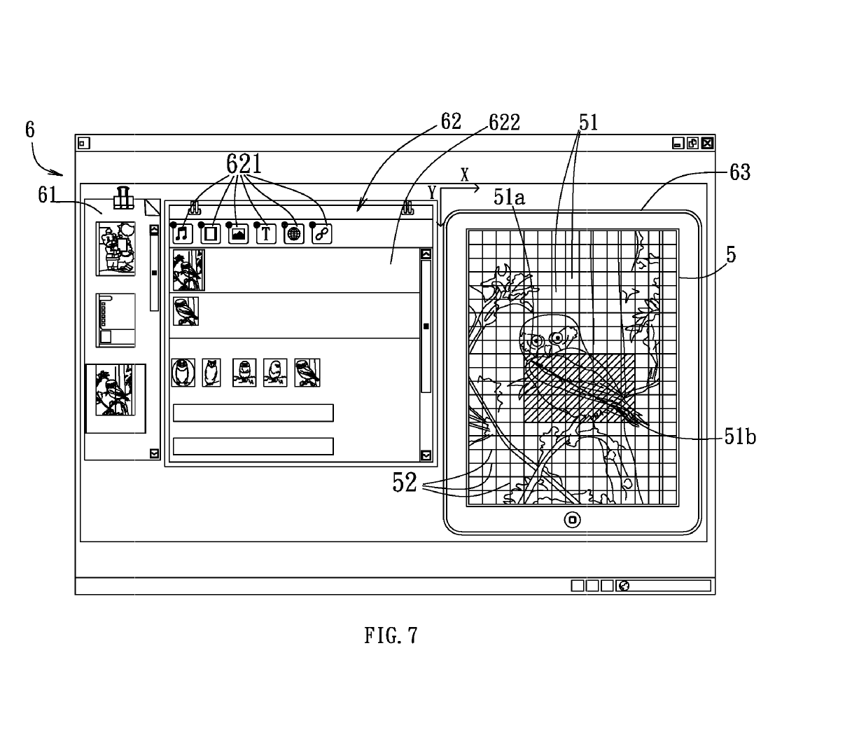

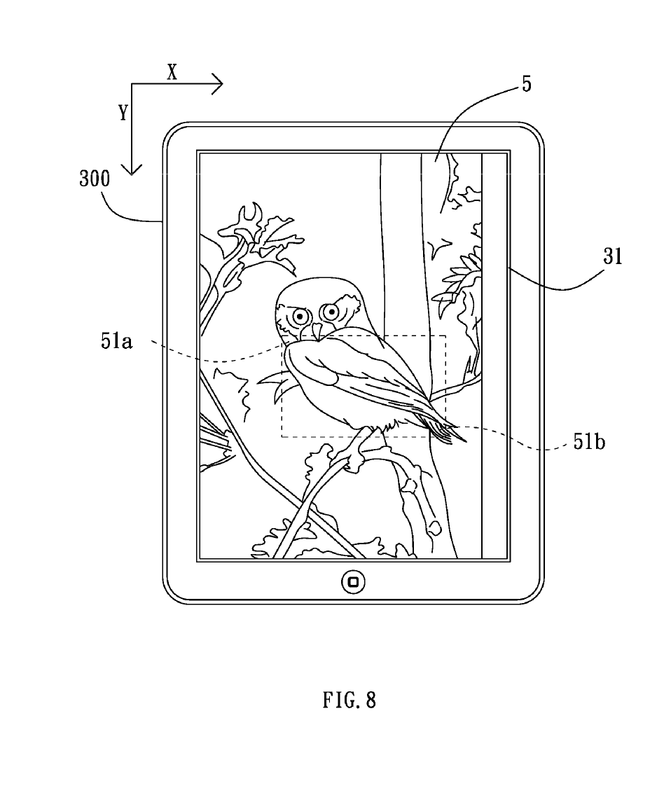

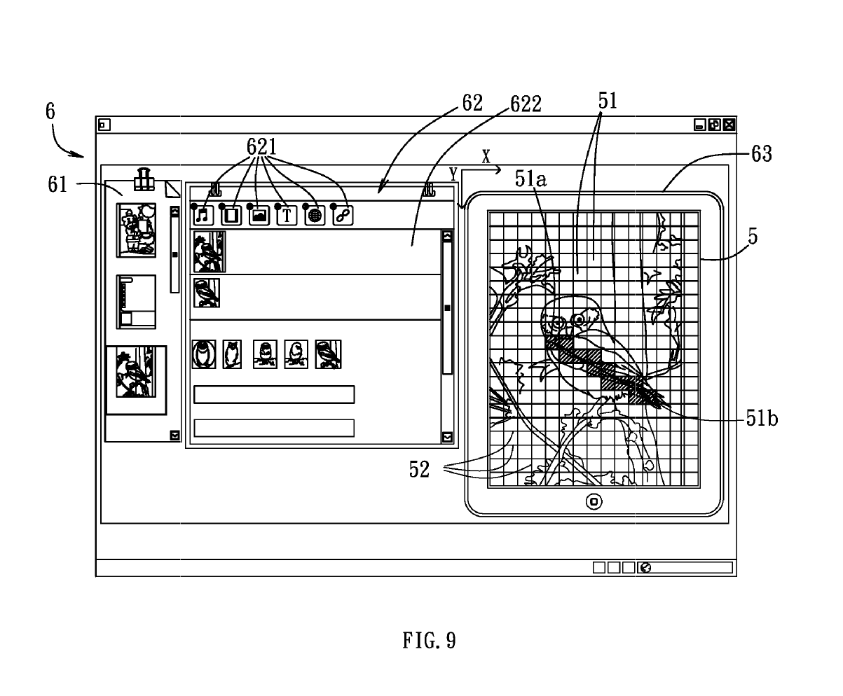

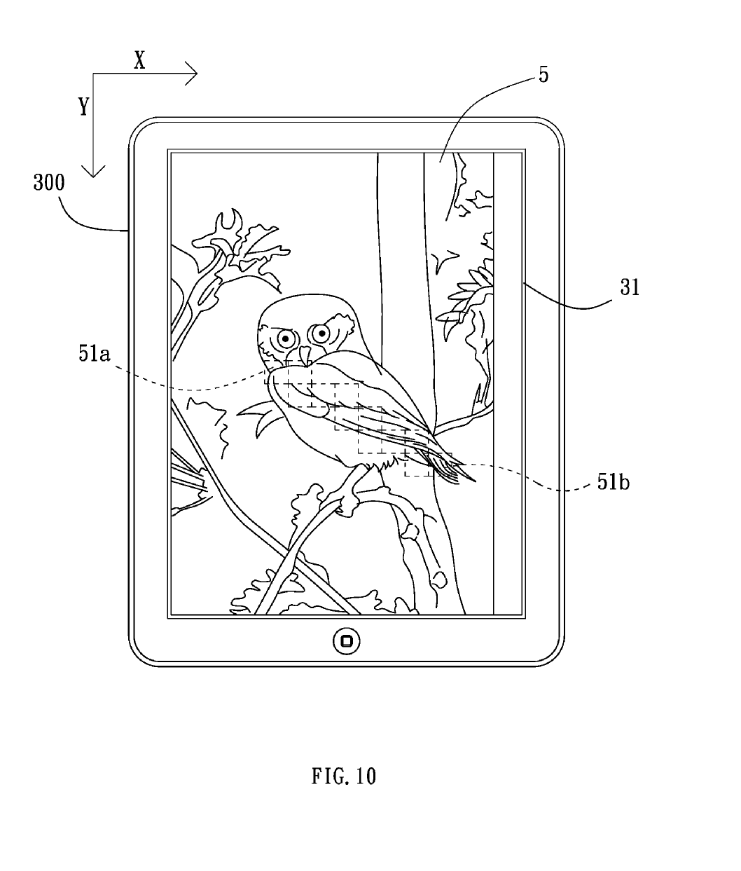

The controller 10 is a central processing unit, configured to coordinate and control operations of respective components. The input unit 11 may be a keyboard or mouse, for example, which can be used for inputting texts, or selecting commands by users during the editing process. The display unit 13 is controlled by the controller 10 to display an editing picture 6 as shown in FIG. 7 or FIG. 9. The output unit 14 may be a network interface. After the application product 2 is completely manufactured, the application product 2 can be downloaded and installed in the electronic device 300 as shown in FIG. 8 or FIG. 10 via the output unit 14, such as a 3G communication network.

The application product 2 comprises a main program 120, region allocation data 122, effect linking data 123, and effect data 121. The main program 120 adopts the development program kits of electronic book software, and the main program 120 is executed by the controller 10 to control the access of the effect data 121, the region allocation data 122, and the effect linking data 123.

Incorporating with FIG. 7, the editing picture 6 comprises a page thumbnail region 61, an editing region 62, and a preview region 63.

The page thumbnail region 61 mainly displays page thumbnails, and marks the page thumbnail which is currently edited with a frame. The preview region 63 displays the page which is currently edited. The editing region 62 comprises several multimedia buttons 621 and an editing window 622. Users can select corresponding multimedia button 621 according to the effect which is expected to be added into the e-book, and users can load required effects in the editing window 622 according to the respective multimedia property.

Referring to FIG. 3 again, in the embodiment, the effect data 121 may be a cover flow provided to the main program 120 for displaying, a webpage address provided to the main program 120 for opening, another e-book page provided to the main program 120 for connecting, a specific address provided to the main program 120 for positioning in an electronic map, a specific longitude and latitude provided to the main program 120 for positioning in an electronic map, a sound file provided to the main program 120 for playing back, a video file provided to the main program 120 for playing back, a photo provided to the main program 120 for displaying, and/or a text file provided to the main program 120 for displaying.

Referring to FIG. 4, the steps of the effect editing method for electronic books of the present invention is disclosed as follows.

Step 401: the page of an e-book is separated into a plurality of sub-regions, and a position parameter is set for each sub-region.

Incorporating with FIG. 3 and FIG. 7, in step 401 of the embodiment, the main program 120 presets the e-book page 5 to be divided into 20×15 sub-regions 51, in which each sub-region may have a width approximate to a finger tip. It is noted that, in some embodiments, the e-book page 5 can be also divided into more sub-regions having a smaller size than that of the above example. It is understood that, the number and width of the sub-region are not limited thereto.

Step 402: a first position parameter corresponding to a first sub-region 51a, which is selected at beginning, and a second position parameter corresponding to a second sub-region 51b, which is selected at ending, and the position parameters between the first position parameter and the second position parameter.

Incorporating with FIG. 3 and FIG. 7, for the sake of convenient editing, the e-book page 5 further displays several grid lines 52 which separating the sub-regions 51. The grid lines 52 can help users to distinguish the position of the sub-region 51. When users select at least one or several sub-regions, the selected sub-regions will be reversed-out, such as the selected sub-regions 51a and 51b. Then, the respective position parameters corresponding to the selected sub-regions 51a and 51b, and the position parameters between the first position parameter and the second position parameter are recorded as region allocation data 122.

The automatic selection recording may be implemented in two manners, which are respectively discussed as follows.

Referring to FIG. 5, the first position parameter corresponding to the sub-region 51a, which is triggered by a selection action of a mouse (step 601), and the second position parameter corresponding to the sub-region 51b, which is triggered by a release action of the mouse (step 602), and the position parameters between the first position parameter and the second position parameter are automatically calculated (603). In the embodiment, as shown in FIG. 7, the automatically calculated area is the rectangle region whose diagonal line connecting the first position parameter and the second position parameter.

Referring to FIG. 6, the sub-region 51a which is triggered by the mouse movement action is recorded (step 701). It is determined whether the mouse movement action is terminated (step 702). If so, the position parameters corresponding to the selection path during the mouse movement action are recorded (step 703), in which the position parameters corresponding to the selection path includes the position parameters between the first position parameter of the first sub-region 51a, which is selected at beginning, and the second position parameter of the second sub-region 51b, which is selected at ending. In the embodiments, as shown in FIG. 9, the automatically calculated area includes the sub-regions passed by the mouse movement track.

Step 403: the first position parameter and the second position parameter corresponding to the selected sub-regions 51a and 51b, and the position parameters between the first position parameter and the second position parameter are linked to an effect.

In step 403 of the embodiment, the position parameters corresponding to the selected sub-regions 51a and 51b, and the position parameters between the first position parameter and the second position parameter are linked to the effect data 121, and recorded as the effect linking data 123. It is noted that, the position parameter is the absolute position relative to the entire e-book page 5, but not the absolute position relative to the touch-sensitive screen 31. Therefore, the linking relationship between the position parameters corresponding to the selected sub-regions 51a and 51b, the position parameters between the first position parameter and the second position parameter, and the effect data 121 will not change even though the e-book page 5 is magnified or moved.

An example of the effect content and the region allocation coordinate parameter of above effect linking is followed.

```
  <dict>
  <key>Title</key>
  <string></string>
  <key>CoverflowSet</key> Note: the effect is displaying cover flow.
  <array>
  <string>page_221_image_324_20100810145152.png</string>
  </array><key>Grid</key>
  <array>
  <dict> Note: the position parameter is (5,10).
  <key>x</key><integer>6</integer>
  <key>y</key><integer>9</integer>
  </dict>
  Note: the program codes of the middle position parameters are similar,
and omitted here.
  <dict> Note: the below position parameter is (12,14).
  <key>x</key><integer>7</integer>
  <key>y</key><integer>9</integer>
  </dict>
  </array>
```

Step 404: the touch-sensitive screen of the electronic device is enabled to display the e-book page, and the effect is performed when the selected sub-region is triggered.

Referring to FIG. 8 or FIG. 10, the electronic device 300 downloads the application product 2, which is completely edited. When the main program is executed, the touch-sensitive screen 31 is enabled to display the e-book page 5, and the corresponding effect is performed when the selected sub-regions 51a, 51b, or any sub-region between the sub-regions 51a and 51b is triggered.

Therefore, the electronic device 300 of the present invention executes predefined program logic, wherein the predefined program logic links the position parameters corresponding to the sub-regions 51a and 51b, and the sub-regions between the sub-regions 51a and 51b to an effect, makes the touch-sensitive screen 31 of the electronic device 300 to display the e-book page 5, and performs the effect when the selected sub-regions 51a and/or 51b is triggered.

That is, during the execution of the application product 2 by the electronic device 300, users can control to flip the e-book, such that the touch-sensitive screen 31 displays the e-book page 5. The e-book page 5 has invisible buttons having a width approximate to a finger tip, and the sub-regions 51a and 51b respectively correspond to allocation position parameters (5,10) and (12,14). Since the position parameters (5,10) and (12,14) have been recorded and linked to the effect of “displaying cover flow”, the effect of “displaying cover flow” is performed when the sub-regions 51a, 51b, or any sub-region between the sub-regions 51a and 51b is selected by users.

Therefore, the efficacy of the effect editing methods, systems, application products and electronic devices for electronic books of the present invention can automatically select several sub-regions, thereby reducing the operational time of one by one selection, and improving the manufacturing efficiency of e-books.

Effect editing methods for electronic books, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. When implemented on a general-purpose processor, the program code combines with the processor to provide a unique apparatus that operates analogously to the application of specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An effect editing method for electronic books (e-books) for editing an e-book page displayed on a touch-sensitive screen of an electronic device, wherein the method comprising:
(a) separating the e-book page into a plurality of sub-regions, each having a position parameter;
(b) recording a first position parameter corresponding to a first sub-region, which is selected at beginning, a second position parameter corresponding to a second sub-region, which is selected at ending, and position parameters between the first position parameter and the second position parameter; and
(c) linking the first position parameter and the second position parameter corresponding to the selected sub-regions, and the position parameters between the first position parameter and the second position parameter to an effect, thus making the touch-sensitive screen of the electronic device to display the e-book page, and performing the effect when the selected sub-region is triggered.

2. The method of claim 1, wherein in step (b), the first position parameter triggered by a mouse selection action, and the second position parameter triggered by a mouse release action are recorded, and the position parameters between the first position parameter and the second position parameter are automatically recorded.

3. The method of claim 1, wherein in step (b), the position parameters corresponding to a selection path during a mouse movement action are recorded in response to the mouse movement action.

4. The method of claim 1, wherein step (a) further comprises the step of displaying several grid lines which separating the sub-regions.

5. The method of claim 1, wherein the effect in step (c) is to display a cover flow, open a webpage address, connect to another e-book page, position a specific address in an electronic map, position a specific longitude and latitude in an electronic map, play back a sound file, play back a video file, display a photo file, or display a text file.

6. An effect editing system for electronic books, comprising:
a controller configured to coordinate and control operations of respective components;
a display unit, controlled by the controller, for displaying an e-book page to be displayed in a touch-sensitive screen of an electronic device; and
a memory provided to the controller for accessing data, storing an application product, wherein the application product comprises:
region allocation data corresponding to the sub-regions divided from the e-book page, and recording position parameters corresponding to the respective selected sub-regions;
effect linking data recording a first position parameter corresponding to a first sub-region, which is selected at beginning, and a second position parameter corresponding to a second sub-region, which is selected at ending, in which the first position parameter and the second position parameter corresponding to the selected sub-regions, and position parameters between the first position parameter and the second position parameter are linked to an effect; and
a main program provided to the controller, when executed, making the touch-sensitive screen to display the e-book page, and performing the effect when the selected sub-region is triggered.

7. The system of claim 6, wherein the effect linking data records the first position parameter triggered by a mouse selection action, and the second position parameter triggered by a mouse release action, and the position parameters between the first position parameter and the second position parameter are automatically recorded.

8. The system of claim 6, wherein the effect linking data records the position parameters corresponding to a selection path during a mouse movement action in response to the mouse movement action.

9. The system of claim 6, wherein the display unit further displays several grid lines which separating the sub-regions.

10. The system of claim 6, wherein the memory further stores effect data, wherein the effect data is a cover flow provided to the main program for displaying, a webpage address provided to the main program for opening, another e-book page provided to the main program for connecting, a specific address provided to the main program for positioning in an electronic map, a specific longitude and latitude provided to the main program for positioning in an electronic map, a sound file provided to the main program for playing back, a video file provided to the main program for playing back, a photo provided to the main program for displaying, or a text file provided to the main program for displaying.

11. An application product of electronic books for executed in an electronic device comprising a touch-sensitive screen for displaying an e-book page, wherein the application product is characterized in:
the e-book page is divided into a plurality of sub-regions, each having a position parameter;
a first position parameter corresponding to a first sub-region, which is selected at beginning, a second position parameter corresponding to a second sub-region, which is selected at ending, and position parameters between the first position parameter and the second position parameter are linked to an effect; and
the touch-sensitive screen of the electronic device is enabled to display the e-book page, and the effect is performed when the selected sub-region is triggered.

12. The application product of claim 11, wherein the effect linking data records the first position parameter triggered by a mouse selection action, and the second position parameter triggered by a mouse release action, and the position parameters between the first position parameter and the second position parameter are automatically recorded.

13. The application product of claim 11, wherein the effect linking data records the position parameters corresponding to a selection path during a mouse movement action in response to the mouse movement action.

14. The application product of claim 11, wherein the effect is to display a cover flow, open a webpage address, connect to another e-book page, position a specific address in an electronic map, position a specific longitude and latitude in an electronic map, play back a sound file, play back a video file, display a photo file, or display a text file.

15. An electronic device, for executing predefined program logic, wherein the predefined program logic links first position parameter corresponding to a first sub-region, which is selected at beginning, a second position parameter corresponding to a second sub-region, which is selected at ending, and position parameters between the first position parameter and the second position parameter to an effect, makes the touch-sensitive screen of the electronic device to display the e-book page, and performs the effect when the selected sub-region is triggered.
